(19) United States
(12) Patent Application Publication
(10) Pub. No.: US 2025/0383946 A1
(43) Pub. Date: Dec. 18, 2025

(54) DATA CORRUPTION DETECTION FOR ELECTRONIC DEVICES

(71) Applicant: Intel Corporation, Santa Clara, CA (US)

(72) Inventors: Amir Zaltzman, Kfar Saba (IL); Ohad Konovitch, Ruhama (IL); Shlomo Avni, Ein Hamifratz (IL); Michael Lopatnikov, Rehovot (IL)

(73) Assignee: Intel Corporation, Santa Clara, CA (US)

(21) Appl. No.: 18/745,737

(22) Filed: Jun. 17, 2024

(51) Int. Cl. G06F 11/07

(52) U.S. Cl. CPC G06F 11/0751; G06F 11/0745

(57) ABSTRACT

An apparatus comprising a bus to communicate a plurality of signal sets in a plurality of transactions; first circuitry to generate a first signature based on the plurality of signal sets communicated by the bus, wherein the first circuitry is to update a signature based on a current value of the signature and a valid incoming signal set; and second circuitry to provide the first signature for comparison with a second signature.

### TECHNICAL FIELD

This disclosure relates in general to the field of computing systems and, more particularly, to data corruption detection for electronic devices.

### BACKGROUND

Electronic device debugging generally focuses on identifying and resolving issues in the functionality of components (e.g., integrated circuits). Debugging may encompass design verification, simulation, and testing to find and remedy problematic components. In some instances, engineers may use software-based debugging environments to monitor signals, inspect internal states, and trace the root causes of problems occurring in logic of an electronic device.

### BRIEF DESCRIPTION OF THE DRAWINGS

FIG. 1 illustrates a system comprising data corruption detectors and comparison logic to detect data corruption at two different points of a bus in accordance with certain embodiments.

FIG. 2 illustrates a system comprising a data corruption detector and comparison logic to detect data corruption at a single point of a bus in accordance with certain embodiments.

FIG. 3 illustrates a system comprising data corruption detectors to verify correct operation of a first in first out (FIFO) in accordance with certain embodiments.

FIG. 4 illustrates a data corruption detector in accordance with certain embodiments.

FIG. 5 illustrates a flow for generating a signature based on bus transactions in accordance with certain embodiments.

FIG. 6 illustrates a flow for detecting data corruption in accordance with certain embodiments.

FIG. 7 illustrates a computing system in accordance with certain embodiments.

FIG. 8 illustrates an example electronic device that may include a microelectronic assembly, in accordance with certain embodiments.

Like reference numbers and designations in the various drawings indicate like elements.

### DESCRIPTION OF EXAMPLE EMBODIMENTS

Over the years, electronic device complexity has dramatically increased. As one example, current flagship semiconductor processor products have transistor counts that well exceed 10 billion. The complexity of electronic devices makes debugging errors within the devices a daunting task.

Data signals (e.g., including data, addresses, or control information) may travel on communication buses in between various logic blocks of an electronic device. Data corruption refers to any error in data, address, control information (e.g., transaction IDs), or other information that is sent on a bus. An error may occur during writing, reading, transmission, or processing of the information. An error may occur due to any of various reasons, such as a logic bug, timing issue, unintended configuration, or circuit marginality. Data corruption errors are difficult to debug since detection might be chronologically or physically far from the cause of the corruption.

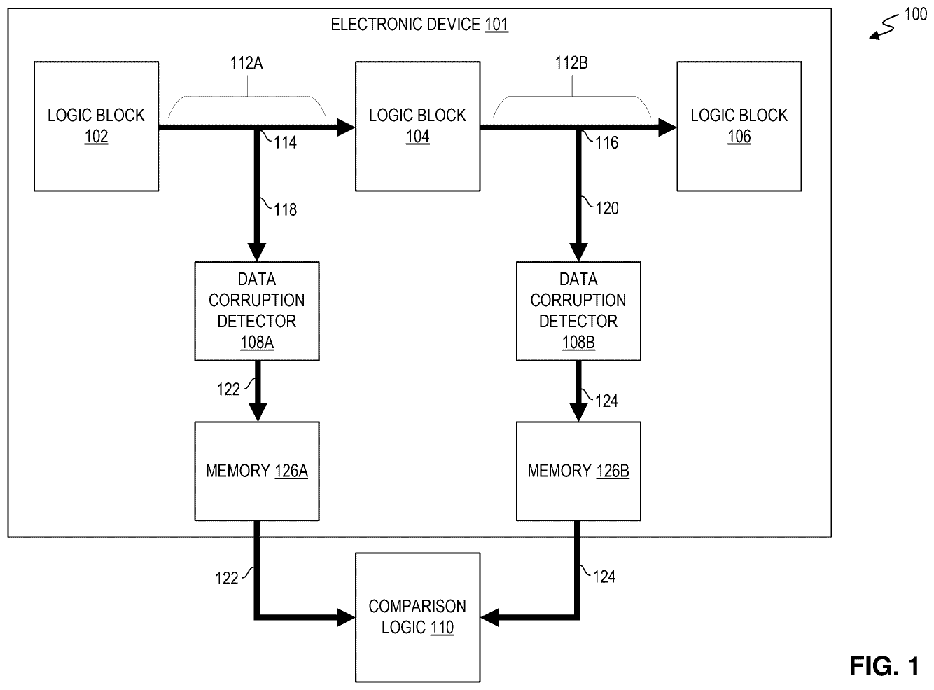

FIG. 1 illustrates a system 100 with data corruption detectors 108 (e.g., 108A, 108B) and comparison logic 110 to detect data corruption at two different locations 114, 116 of a bus 112 in accordance with certain embodiments. The data corruption detectors 108 may enable a cost-effective solution to detect data corruption in silicon debug. System 100 generates and compares signatures that are based on a history of events (also referred to herein as transactions) on a bus at pre-selected locations in order to identify the location and point in time of the data corruption.

In various embodiments, in addition to a signature generator, a data corruption detector 108 may also include an event counter to track the number of events that are used by the signature generator to generate a signature (e.g., the number of events upon which the signature is based). The event counter may be useful to ensure that signatures being compared are based on the same number of events (and thus the event counter may be used to detect instances of packet loss).

The comparison of signatures and/or event counters can be performed at any suitable time, such as when electronic device 101 is hung (e.g., not advancing as expected), electronic device 101 is halted (e.g., stopped on purpose, e.g., by quiescing one or more clock signals), responsive to a selected event (e.g., entry of the electronic device 101 or a portion thereof into a low power state, detection of an error, an on-demand request to perform the comparison issued by debugging software or other logic, etc.), or at regular or irregular intervals. The signatures may be compared at different locations of the bus (point-to-point comparison) or at the same location but at different runs (single point comparison) (e.g., in a pass versus fail scenario). Upon detection of an error due to a mismatch of signatures and/or event counters, the error can be hooked to trigger debug mechanisms to allow further debugging of the error. For example, detection of an error may trigger collection of a pre-defined list of registers which can help to triage and analyze the reason for the error; halting of the system and/or gating of one or more clocks (e.g., by a micro-breakpoint controller) to enable dumping of array values or shifting out of flip flop data using a scan mechanism; communication of the error to debug fabric (e.g., Intel VISA) to send the error to debug pins, halt the system, or take tracing; or sending of a machine check exception.

Various embodiments of the present disclosure may provide one or more technical advantages, such as a simple and quick way to isolate, detect, and debug data corruption; a continuous health check to detect corruption during system (e.g., system on chip (SOC)) activity; detection of packet loss and/or transaction misordering (thus providing a benefit beyond per-transaction error detection mechanisms, such as parity checks, cyclic redundancy checks, or error correction codes), error detection in bus fields including a data signals, address signals, and/or control signals (e.g., a source ID, a destination ID, a transaction ID, communication credit information, or other field carried on a separate signal from the data or address), higher detection rate relative to other correction mechanisms (e.g., parity has a 50% error detection rate, while various embodiments may enable high detection rates, such as higher than 90% or even higher than 95%).

Electronic device 101 includes a logic block 102 that is to provide signals for communication over a first bus segment 112A of a bus 112 to a logic block 104. The logic block 104 may provide signals for communication over a second bus segment 112B of the bus 112 to a logic block 106. The logic block 102 may comprise any suitable circuitry to generate and/or provide signals to be communicated over the bus 112. Signal sets (e.g., where a signal set may refer to a group of signals on the bus at a particular instant of time) may be communicated over the bus in concert with a clock signal. For example, in a first cycle of the clock a first signal set is communicated in a first transaction, in a second cycle of the clock a second signal set is communicated in a second transaction, and so on. In some embodiments, a cycle of the clock may refer to a period of time from an edge of the clock to a corresponding edge of the clock. For example, a cycle of the clock may refer to the period of time from a rising edge of the clock to the next rising edge of the clock or from a falling edge of the clock to the next falling edge of the clock. In another example, a cycle of the clock may refer to the period of time from a rising edge of the clock to a falling edge of the clock and/or from a falling edge of the clock to a rising edge of the clock (e.g., where a new transaction is sent each time the clock toggles).

At a first location 114 of the bus 112, various signal lines 118 of the bus are routed to a data corruption detector 108A. In various embodiments, the signal lines 118 may be a subset of the signal lines of the bus 112 or may be all of the signal lines of the bus 112. For example, the signal lines may include one or more data lines, one or more address lines, or one or more control lines (e.g., communicating a source ID, a destination ID, a transaction ID, communication credit information, or other suitable control information).

Logic block 104 may comprise any suitable circuitry to store and/or manipulate the signals of the bus 112. For example, the logic block 104 may comprise routing circuitry, arbitration circuitry, buffering circuitry, memory circuitry, or other suitable circuitry. For the bus signals that are communicated on bus segment 112A and are to be used to generate signatures by data corruption detector 108A, the same bus signals should be communicated on bus segment 112B (and in the same order if the signatures generated by the data corruption detectors 108 are dependent on signal order). Thus, any changes made by logic block 104 to signals that will be used in generation of the signatures by the data corruption detectors 108A and 108B should be reversed by the logic block 104 such that the same values of these signals are supplied to the data corruption detectors. For example, if the logic block 104 compresses and/or encrypts signals, the logic block 104 may decompress and/or decrypt the signals. As another example, if the logic block 104 performs protocol translation on the signals, it may also translate the signals back to the initial protocol. As yet another example, if the logic block 104 packetizes signals, it may also depacketize the signals. In some instances, logic block 104 does not change the values and/or formatting of the signals (e.g., the logic block 104 may simply store the signals, such as in a first in first out (FIFO) memory structure).

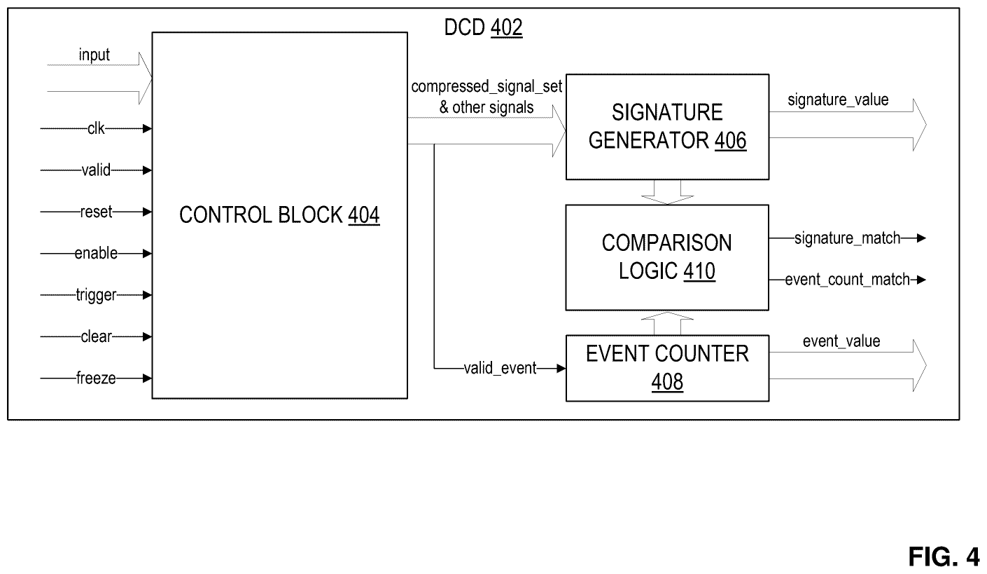

The data corruption detector 108A may receive input signals over signal lines 118 from location 114 of the bus 112 and may generate a signature 122 based thereon. For each valid set of input signals on signal lines 118, the detector 108A will update the signature and an event counter (more information will be provided later in connection with FIG. 4 as to what may constitute a valid set of input signals for a detector). In a like manner, data corruption detector 108B may receive input signals over signal lines 120 from location 116 of the bus 112 and may generate a signature 124 based thereon. For each valid set of input signals on signal lines 120, the detector 108B will update the signature and an event counter.

A data corruption detector 108 may include any suitable circuitry to generate a signature, such as an accumulator, a multiple input shift register (MISR), a linear feedback shift register (LFSR), other signature mechanism, or combinations thereof. The signature generated by any of these signature generators is based on the entire history of the valid sets of input signals. Accordingly, the system 100 checks the integrity of the input signal sets, such that if one set of signals was missed by one detector but wasn't missed by the other detector, then the signatures will not match. Similarly, if a value of an input signal of an input signal set provided to detector 108A is different from a corresponding input signal of a corresponding input signal set provided to detector 108B, then the signatures will be different. In various embodiments (for example when an MISR or LFSR is used), the signature may also be dependent on the ordering of the sets of input signals, whereas in other embodiments (for example when an accumulator is used), the signature is not dependent on the ordering of the signal sets (thus the signal sets could be communicated in a different order on bus segment 112A than on bus segment 112B, but still result in the same signature value for signatures 122 and 124).

At a point in time in which the signature values and/or event counter values are expected to be the same (e.g., after the bus has been quiesced to allow all the transactions on bus segment 112A to propagate to location 116), the signatures 122 and 124 and/or respective event counter values are compared by comparison logic 110 to determine whether they are equal (e.g., if the value of each bit of a signature or event counter value matches the values of bits of a corresponding signature or event counter value). If they are not equal, then it is known that an error occurred between location 114 and location 116. In some embodiments, a debugger may then proceed to perform a low level debug on a focused area (e.g., logic block 104).

In the embodiment depicted, memory 126A (e.g., a register or other memory element) may be used to store the signature 122 and/or associated event counter while memory 126B may be used to store the signature 124 and/or associated event counter. In some instances, a single memory comprising one or more registers or other memory elements may be used to store signatures and/or event counters from any number of data corruption detectors 108. In various embodiments, the memory used to store the signatures and/or event counters may be part of the data corruption detectors 108 (e.g., integrated with or coupled to the signature generators and/or event counters of the detectors 108). In other embodiments, signatures (or event counters) may be compared in real time, such that they do not need to be read from registers or other memory before comparison, but rather the signatures (or event counters) may be supplied by the signature generators to comparison logic directly.

Comparison logic comprises any suitable logic to compare signatures and/or event counter values and to determine whether they match. In this embodiment, the comparison logic 110 is shown as separate from and coupled to the electronic device (e.g., comparison logic 110 may be present on a system that executes a debugger or some other computing system external to the electronic device 101), although in other embodiments, the comparison logic 110 may be included on the electronic device 101 itself. The comparison logic 110 may read the signatures and/or event counters from memory at any suitable time and perform the comparison.

In various embodiments, any number of data corruption detectors 108 may be present and coupled to various locations of one or more buses of the electronic device. Comparison logic 110 may be coupled to any number of these data corruption detectors 108 (or separate instances of comparison logic 110 may be coupled to subsets of these data corruption detectors).

In many cases, during debug, a comparison between different points is desirable to determine whether a transaction was corrupted in between the two points. This may be done between two interfaces (e.g., a sender and a receiver) on the same interconnect fabric or in sensitive areas such as clock or power domain crossing. In order to perform the point-to-point comparison, the electronic device 101 (or a portion thereof) may be halted at the desired point in time to allow any pending transactions to complete. Thus, the same number of transactions (e.g., as indicated by an event counter) and the same data and/or other information (e.g., as indicated by a signature) is expected to be transferred between these two points. A mismatch between the signatures means that data corruption has occurred somewhere between the two points. For example, if the logic block 104 is a FIFO, once the FIFO is empty and if additional transactions do not enter the FIFO, then the signature of the data corruption detector 108A on the write side of the FIFO should be equal to the signature of the data corruption detector 108B on the read side, at any point of test or time.

In various embodiments, the comparison of signatures may be expanded beyond point-to-point comparisons to other configurations. For example, the detector configurations may be one-to-multiple, multiple-to-one, or multiple-to-multiple.

In a one-to-multiple configuration, a single location of a bus is connected to a first data corruption detector (that is, multiple signal lines from a location on the bus are provided as inputs to the data corruption detector, in a similar manner to that shown in FIG. 1), while signal lines from multiple locations of one or more buses (e.g., from the same and/or different buses) are connected to a second data corruption detector (and the signature generated by the second detector may be based on valid signal sets aggregated from the multiple points). Such a configuration may be useful where the aggregated transactions sent through the multiple locations are expected to be the same set of transactions as the transactions sent through the single location. For example, such a configuration could be used to test a demultiplexer, with the first data corruption detector coupled to the input of the demultiplexer and the second data corruption detector coupled to each output of the demultiplexer.

In a multiple-to-one configuration, signal lines from multiple locations of one or more buses are connected to a first data corruption detector (and the signature generated by the first detector may be based on valid signal sets aggregated from the multiple locations) while a single location of a bus is connected to a second data corruption detector. Such a configuration may be useful where the transactions sent through the single location are expected to be the same set of transactions as the aggregated transactions sent through the multiple locations. For example, such a configuration could be present to test a multiplexer, where the first data corruption detector is coupled to each input of the multiplexer and the second data corruption detector is coupled to the output of the multiplexer. In another example, multiple components (e.g., an intelligence processing unit, vision processing unit, microcontroller, etc.) may access a memory through a memory controller. Signal lines coupled to the various components may be coupled to a first data corruption detector and signal lines coupled to the memory controller may be coupled to a second data corruption detector.

In a multiple-to-multiple configuration, first multiple locations of one or more buses are connected to a first data corruption detector (and the signature generated by the first detector may be based on valid signal sets aggregated from the first multiple locations) and second multiple locations of one or more buses (the same or different buses) are connected to a second data corruption detector (and the signature generated by the second detector may be based on valid signal sets aggregated from the second multiple locations). Such a configuration may be useful where the aggregated transactions sent through the first multiple locations are expected to be the same transaction set as the aggregated transactions sent through the second multiple locations.

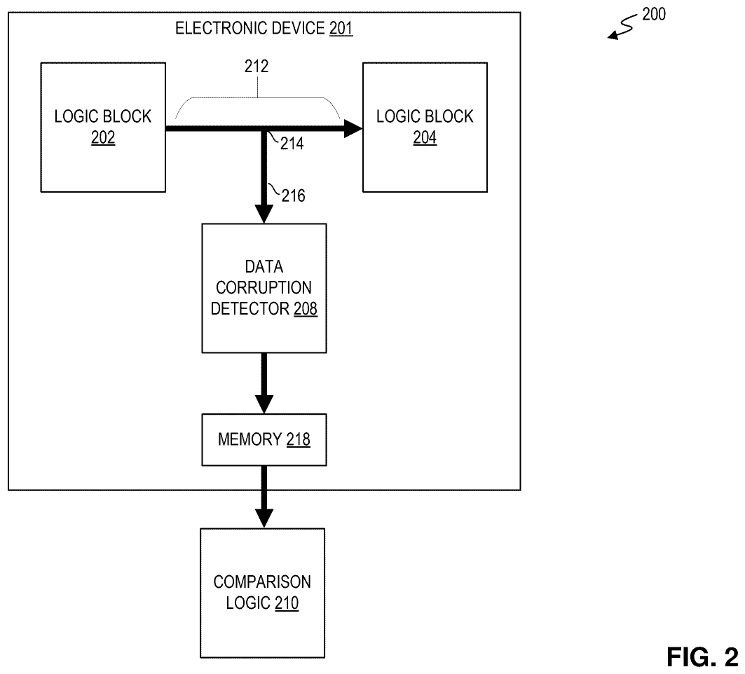

FIG. 2 illustrates a system 200 comprising a data corruption detector 208 and comparison logic 210 to detect data corruption at a single location of a bus 212 in accordance with certain embodiments. The system 200 may enable, e.g., signature comparison of transactions between passing and failing scenarios. For example, there are some instances in which the electronic device 201 may be halted (e.g., by halting a finite state machine or firmware) at deterministic point(s) of the flow in passing and failing scenarios. In such cases, signature comparison may be performed for one or more data corruption detectors in passing and failing conditions. Thus, the debugger can follow the transaction even if it changes between protocols. One example use case includes checking a download of firmware. For example, a first download of firmware may result in generation of a first signature based on signals of the bus communicating the firmware and a second download of the firmware may result in generation of different signature (thus indicating that either the firmware was changed or some other error occurred).

The various components of system 200 may have any suitable characteristics of corresponding components described elsewhere herein. In system 200, bus 212 couples logic block 202 to logic block 204. The data corruption detector 208 is coupled to a single location 214 on the bus 212. A plurality of signal lines 216 from the bus 212 are routed to the data corruption detector 208. During a first window, a plurality of sets of signals are communicated across the bus and to the data corruption detector 208 via signal lines 216. As each set of signals is received, the data corruption detector 208 may update the signature based on the current signature value and the values of the signals in the set. Upon the close of the first window, the signature output by the data corruption detector 208 may be stored in a memory 218 (e.g., a register or other suitable memory element). In various embodiments, the memory 218 may be included within electronic device 201 and/or the comparison logic 210 may include the memory. In some embodiments, the comparison logic 210 may access the memory to retrieve one or more signatures stored therein. At some point, a second window may begin in which another plurality of sets of signals are communicated across the bus and to the data corruption detector 208 via signal lines 216. Again, as each set of signals is received during the second window, the data corruption detector 208 may update the signature based on the current signature value and the values of the signals in the set. Upon the close of the second window, the signature output by the data corruption detector 208 may optionally be stored in a memory. Comparison logic 210 compares the signature from the first window to the signature from the second window. In some embodiments, the comparison logic 210 may also compare an event counter from the first window against an event counter from the second window. If the signature values match, then it may be assumed that no data corruption error is present.

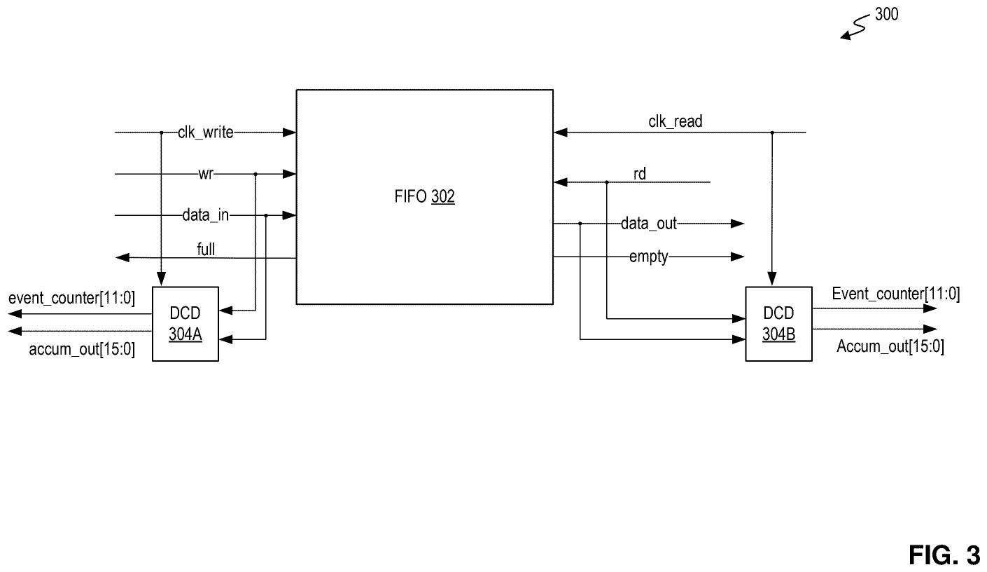

FIG. 3 illustrates a system 300 comprising data corruption detectors 304 (304A, 304B) to verify correct operation of a FIFO 302 in accordance with certain embodiments. The data corruption detectors may have any suitable characteristics of other data corruption detectors described herein. A bus segment between the FIFO 302 and logic (not shown) that is to provide write data to the FIFO 302 includes signal lines for data (data_in) and control (clk_write, wr, and full) signals. Similarly, a bus segment between the FIFO 302 and logic (not shown) that is to receive read data from the FIFO 302 includes signal lines for data (data_out) and control (clk_read, rd, and empty) signals.

The write signal (wr) and the clock for the write signal (clk_write) as well as the input data (data_in) is provided to the data corruption detector 304A via respective signal lines. The detector 304A may generate a signature based on the input data. In this instance, the detector 304A may determine each valid set of input data signals based on the clk_write and the wr signal (e.g., when the wr signal is asserted and the clk_write signal has a rising edge the detector 304A may assume that a new valid set of data is present). The detector 304A may then update the signature (accum_out[15:0]) based on the current signature value and the values of the data_in signals and increment its event counter (event_counter[11:0]). Thus, each time the FIFO 302 is written to, the detector 304A may update its signature and event counter.

In the embodiment depicted, the data corruption detector 304A may utilize an accumulator to generate the signature. Thus, when a signature is generated, the data_in value (or a value based on the data_in value, such as a compressed version of the data_in value) is added to the current value of the signature (accum_out[15:0]) output by the detector 304A.

Similarly, the read signal (rd) and the clock for the read signal (clk_read) as well as the output data (data_out) is provided to the data corruption detector 304B. The detector 304B may generate a signature based on the output data. In this instance, the detector 304B may determine each valid set of data based on the clk_read and the rd signal (e.g., when the rd signal is asserted and the clk_read signal has a rising edge the detector 304B may assume that a new valid set of data is present). The detector 304B may then update the signature (Accum_out[15:0]) based on the current signature value and the value of the data_out signals and increment its event counter (Event_counter[11:0]). Thus, each time the FIFO 302 is read from, the detector 304B may update its signature and increment its event counter. Although particular bus sizes are depicted for the outputs of the data corruption detectors 304A and 304B, in various embodiments, these buses may be any suitable size.

In this embodiment, whenever the FIFO is empty, the signatures and event counters generated by detector 304A and 304B are expected to be equal. If a mismatch is detected in either of these, then a data corruption error occurred somewhere in the FIFO 302.

FIG. 4 illustrates a data corruption detector 402 in accordance with certain embodiments. The detector 402 may have any suitable characteristics of any of the data corruption detectors described herein. In this embodiment, the detector 402 includes a control block 404, a signature generator 406, and event counter 408, and comparison logic 410. The control block 404 receives various signals including some or all of input signals (carried on any suitable number of signal lines) and control signals, such as a clock (clk) signal, a valid signal, a reset signal, an enable signal, a trigger signal, a clear signal, and a freeze signal (in other embodiments, additional control signals may be present or some of the control signals displayed may be omitted). The input signals may include any suitable signals that will be used as a basis for the signature generation (e.g., these are the signals that are being checked for errors). For example, input signals may include any one or more of data, address, credits, parity bits, read/write controls, headers, or other suitable signals. Some of these signals (e.g., input signals, valid, and/or clk) may be sent on a bus that is coupled to logic of the system (e.g., logic block 104, logic block 202, FIFO 302, etc.) that is being tested for data corruption errors. Other signals (e.g., control signals, such as valid, reset, enable, trigger, clear, freeze) may be provided from control logic (e.g., a debugger or other software and/or hardware) or derived from signals of the bus. For example, one or more of these control signals may come from a register that may be written to by a debugger or through other suitable means.

In some embodiments, each new set of signals received by the detector 402 is used to generate an updated signature. However, in other embodiments, the sets of signals sent on the bus may be filtered, and only certain sets of signals (e.g., valid sets of signals) on the bus are used to generate updated signatures. In various embodiments, the data corruption detector 402 may determine whether to include a particular signal set in the signature generation in any suitable manner. In one embodiment, the valid signal may indicate whether the particular set of signals being received (e.g., from the bus) by the detector 402 is to be used to generate an updated signature. If the valid signal is not asserted, the signature generator 406 and event counter 408 may ignore the signal set. If the valid signal is asserted, the signature generator 406 may utilize the signal set to update the signature (signature_value) and the event counter 408 may increment the event counter (event_value) responsive to an edge (e.g., rising and/or falling edge) of the clk signal.

Any suitable filtering of the signal sets may be performed inside the control block 404 and/or outside of the control block 404 (e.g., by a debugger or other logic). If the filtering is performed inside the control block 404, in one example, the control may have an internally generated valid signal (e.g., generated by a combination of an external valid signal plus a result indicating whether the filter matches). In some embodiments, the data corruption detector 402 may receive the filtering fields and values that are to be matched to the input signals (and could also receive mask bits indicating which signals to ignore).

As an example of filtering, only signal sets for certain command types (e.g., one or more of write, read, erase, etc.) may be considered for signature generation. As another example, only signal sets within a particular address range may be considered for signature generation. As another example, for a bus that carries memory commands and various notifications, only signal sets for the memory commands may be considered for signature generation. As another example, only signal sets for certain data types may be considered for signature generation. As yet other examples, filters could be applied for one or more source IDs, one or more destination IDs, header values, or specific bit combinations (e.g., in certain signals of the input signals).

The reset signal may perform a general reset of logic within the control block 404, signature generator 406, and/or event counter 408.

The enable signal may disable logic within the control block 404, signature generator 406, and/or event counter 408 without fully resetting the logic. This may be used to provide power savings when the detector 402 is not in use. In some embodiments, the enable signal may be gated with the clk signal (such that the clk signal does not propagate in the detector 402 unless the enable signal is asserted). When valid transactions are received when enable is asserted, the transactions may be used to update the signature and event counter.

The trigger signal provides an indication to start or stop signature generation and event counting. The trigger signal may be based on events happing in the broader system (e.g., the trigger signal may be controlled by a register or other external logic that can dynamically start or stop the accumulation).

The clear signal may clear the signature value and the event counter value (e.g., by resetting the values to their initial values).

The freeze signal may freeze the signature updating and the event counter updating (e.g., even when valid signal sets are received, the signature and event counter are not updated if the freeze signal is asserted).

The control block 404 may receive any suitable signals from a bus and/or other source and control the inputs provided to signature generator 406 and event counter 408. When a signal set received from the bus is to be used in updating the signature, the control block 404 may pass the signal set (or a derivation thereof) to the signature generator 406 along with associated control signals (e.g., a clock signal and/or a valid_event signal). In some embodiments, the control block 404 may compress a signal set received from the bus (including one or more data signals, one or more address signals, and/or one or more other signals) and provide the compressed signal set (compressed_signal) to the signature generator 406 and the signature generator 406 may update the signature_value based on the compressed_signal and the current signature_value. The compression may be performed in any suitable manner. In one embodiment, an XOR tree is used to compress the signal set (e.g., into 16 bits or other number of bits).

The control block 404 may provide a compressed version of the incoming signal set (compressed_signal_set as shown), the uncompressed signal set, or some other variation of the signal set to the signature generator 406. In some embodiments, the control block 404 may also send a clock signal to the signature generator 406 to control when the signature is updated (e.g., the signature may be updated on a rising and/or falling edge of the clock signal). In some embodiments, the clock signal may be the same as the clk signal that is input into the control block 404 or other suitable clock signal. In various embodiments, the control block 404 may also send a qualified enable signal. For example, the qualified enable signal could be a combination of two or more of the signals received by the control block. As just one example, the qualified enable signal may be a combination of valid, enable, trigger, and freeze (such that the qualified enable signal is asserted when valid, enable, and trigger are asserted and freeze is not asserted). The qualified enable signal (when asserted) may indicate to the signature generator 406 that the compressed_signal_set (or uncompressed signal set) is to be used to update the signature upon a rising and/or falling edge of a clock signal. In other embodiments, any other suitable method for notifying the signature generator 406 that a signal set is to be used to update the signature is contemplated herein. The valid_event signal indicates that new data has arrived in the input signals at the data corruption detector and has passed filtering (if any).

The signature generator 406 may output the signature_value (which may be any suitable size) and the event counter 408 may output the event_value (which also may be any suitable size). In some embodiments, comparison logic 410 may compare the signature_value and/or the event_counter against one or more predetermined signature values or event counter values and assert a signature_match or event_count_match signal when a match is found. These signals may be used to trigger any suitable system action, such as a halting of a portion of the system, clock gating, start tracing, or other suitable action.

In some embodiments, in order to synchronously halt data corruption detectors at different points in time, a signal may be provided to the data corruption detector to serve as an indication of whether to sample or not (this is a signal that is dedicated to that purpose). The signal can be set by the sender block, according, for example, to a filtering result or by a control register. This signal may propagate as part of the bus to the data corruption detectors along with other bus signals so that the data corruption detectors will sample or ignore the input signals based on the value of this signal.

In various embodiments, the data corruption detectors may be used in conjunction with a software debugger. For example, one or more of the control signals sent to a detector may be provided by the debugger (e.g., the debugger may control when the detectors are enabled, which filtered transactions will be considered, etc.). As another example, a debugger may read (e.g., from memory such as registers) the signature values, event values, and/or indications of whether the values match (e.g., when the comparison is performed by circuitry of the computing system that includes the detectors). As another example, when a mismatch is detected, a debugger may perform various actions responsive to the detection of the mismatch.

In other embodiments, the data corruption detectors may be used independent of a software debugger (e.g., by using logic external to the computing system to write to control registers and/or read from registers including the signature values, event values, and/or comparison results).

While various embodiments may be used by a manufacturer or other entity to debug systems under development, the use cases are not limited thereto. For example, in some embodiments, the detectors may be utilized by end users to perform functional safety, error reporting, or other operations. As just one example, when a signature mismatch is detected at one or more critical points of a computing system, the computing system may be shut down (e.g., automatically triggered by detection of the mismatch) or other remedial actions taken.

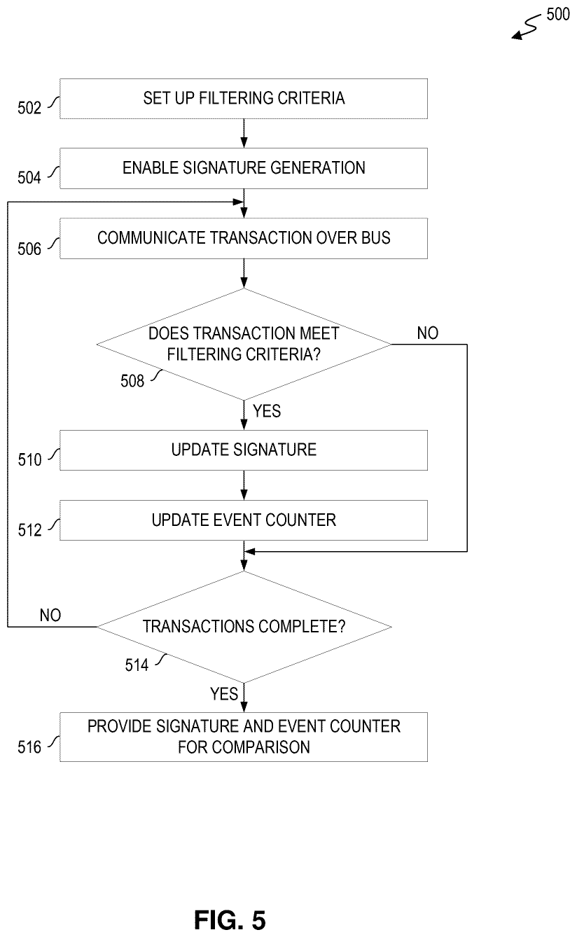

FIG. 5 illustrates a flow 500 for generating a signature based on bus transactions in accordance with certain embodiments. Any operation of the flow may be performed by any one or more components described herein, such as an electronic device, a computing system coupled to an electronic device, a debugger, or other suitable logic.

At 502, filtering criteria is set up. The filtering criteria define, for one or more particular data corruption detectors, what transactions will be considered in signature generation and event counting. Setting up the filtering criteria may include, for example, writing to one or more registers of an electronic device with settings defining the filtering and/or otherwise configuring filtering logic of the electronic device.

At 504, signature generation is enabled. For example, a data corruption detector may be powered up, configured, and/or instructed to begin generating signatures.

At 506, a transaction is communicated over a bus. At 508, a determination is made as to whether the transaction meets the filtering criteria previously set up. If the transaction does not meet the filtering criteria, the signature and event counter of a data corruption detector coupled to the bus are not updated and the flow moves to 514. If the transaction does meet the filtering criteria, the flow moves to 510 where the signature is updated based on at least a portion of values of the signals of the transaction. The event counter associated with that signature is updated at 512.

At 514, a determination is made as to whether the transactions being analyzed are complete. If they are not, the flow moves to 506 where an additional transaction is communicated over the bus and the transaction is used to update the signature and event counter if it meets the filtering criteria. If the transactions are complete, the signature and event counter are provided for comparison at 516. For example, the signature and event counter may be provided for comparison with a signature and event counter from a different data corruption detector or from a signature and event counter updated by the same data corruption detector responsive to a separate set of transactions.

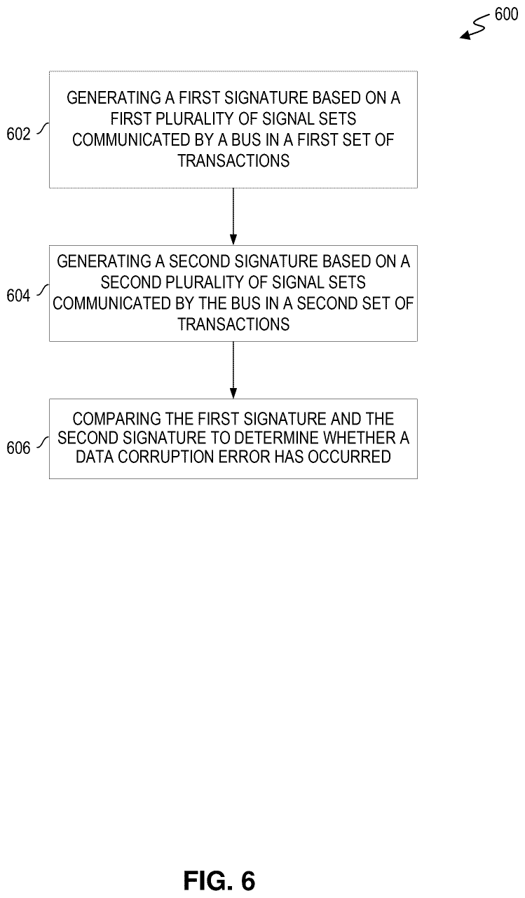

FIG. 6 illustrates a flow 600 for detecting data corruption in accordance with certain embodiments. At 602, a first signature is generated based on a first plurality of signal sets communicated by a bus, wherein the first plurality of signal sets are communicated by the bus in a first set of transactions. At 604, a second signature is generated based on a second plurality of signal sets communicated by the bus, wherein the second plurality of signal sets are communicated by the bus in a second set of transactions. At 606, the first signature and the second signature are compared to determine whether a data corruption error has occurred.

In various embodiments, the flows described herein (e.g., in FIG. 5, FIG. 6, or elsewhere) may include additional operations, omit any of the described operations, perform any of the operations in parallel with one or more other operations, or repeat operations. For example, in order to compare two or more points, signatures may be generated in parallel.

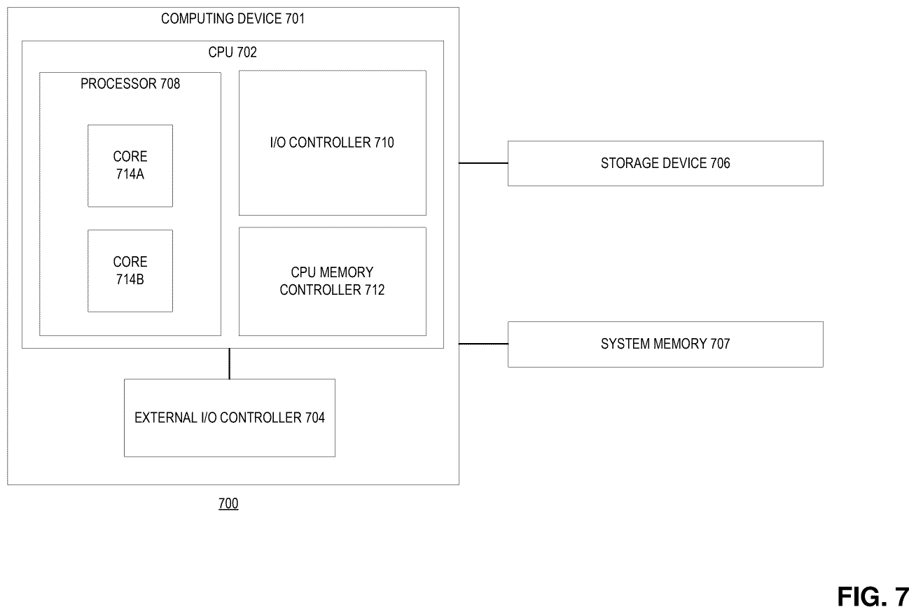

FIG. 7 illustrates a computing system 700 in accordance with certain embodiments. Any suitable components of system 700 may be used to perform any of the functions described above. For example, all or a portion of system 700 may be included within an electronic device (e.g., 101, 201). As another example, any number of data corruption detectors may be included withing system 700 or a component thereof. As yet another example, a debugger may run on system 700 and interact with data corruption detectors of an electronic device (which could also include any of the components of system 700).

System 700 includes a computing device 701 comprising a central processing unit (CPU) 702 coupled to an external input/output (I/O) controller 704, storage device 706, and system memory 707. Although various components are illustrated, computing system 700 may include additional other components or multiples of the components illustrated.

During operation, data may be transferred between storage device 706 or system memory 707 and the CPU 702. In various embodiments, particular data operations (e.g., erase, program, and read operations) involving a storage device 706 or system memory 707 may be managed by an operating system or other software application executed by processor 708.

CPU 702 comprises a processor 708, such as a microprocessor, an embedded processor, a digital signal processor (DSP), a network processor, a handheld processor, an application processor, a co-processor, a system on a chip (SOC), or other device to execute code (i.e., software instructions). Processor 708, in the depicted embodiment, includes two processing elements (cores 714A and 714B in the depicted embodiment), which may include asymmetric processing elements or symmetric processing elements. However, a processor may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core 714 may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

In various embodiments, the processing elements may also include one or more arithmetic logic units (ALUs), floating point units (FPUs), caches, instruction pipelines, interrupt handling hardware, registers, or other hardware to facilitate the operations of the processing elements.

I/O controller 710 is an integrated I/O controller. I/O controller 710 may include logic for communicating data between CPU 702 and I/O devices, which may refer to any suitable devices capable of transferring data to and/or receiving data from an electronic system, such as CPU 702. For example, an I/O device may comprise an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input devices such as a monitor, printer, mouse, keyboard, or scanner; or other suitable device. In a particular embodiment, an I/O device may comprise a storage device 706 that may be coupled to the CPU 702 through I/O controller 710.

An I/O device may communicate with the I/O controller 710 of the CPU 702 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In particular embodiments, I/O controller 710 and the underlying I/O device may communicate data and commands in accordance with a logical device interface specification such as Non-Volatile Memory Express (NVMe) (e.g., as described by one or more of the specifications available at www.nvmexpress.org/specifications/) or Advanced Host Controller Interface (AHCI) (e.g., as described by one or more AHCI specifications such as Serial ATA AHCI: Specification, Rev. 1.3.1 available at http://www.intel.com/content/www/us/en/io/serial-ata/serial-ata-ahci-spec-rev1-3-1.html). In various embodiments, I/O devices coupled to the I/O controller may be located off-chip (i.e., not on the same chip as CPU 702) or may be integrated on the same chip as the CPU 702.

CPU memory controller 712 is an integrated memory controller. In various embodiments, CPU memory controller 712 may include any one or more characteristics of I/O controller 710. CPU memory controller may include logic to control the flow of data going to and from one or more system memories 707. CPU memory controller 712 may include logic operable to read from a system memory 707, write to a system memory 707, or to request other operations from a system memory 707. In various embodiments, CPU memory controller 712 may receive write requests from cores 714 and/or I/O controller 710 and may provide data specified in these requests to a system memory 707 for storage therein. CPU memory controller 712 may also read data from a system memory 707 and provide the read data to I/O controller 710 or a core 714. During operation, CPU memory controller 712 may issue commands including one or more addresses of the system memory 707 in order to read data from or write data to memory (or to perform other operations). In some embodiments, CPU memory controller 712 may be implemented on the same chip as CPU 702, whereas in other embodiments, CPU memory controller 712 may be implemented on a different chip than that of CPU 702. I/O controller 710 may perform similar operations with respect to one or more storage devices 706.

The CPU 702 may also be coupled to one or more other I/O devices through external I/O controller 704. In a particular embodiment, external I/O controller 704 may couple a storage device 706 to the CPU 702. External I/O controller 704 may include logic to manage the flow of data between one or more CPUs 702 and I/O devices. In particular embodiments, external I/O controller 704 is located on a motherboard along with the CPU 702. The external I/O controller 704 may exchange information with components of CPU 702 using point-to-point or other interfaces.

A system memory 707 may store any suitable data, such as data used by processor 708 to provide the functionality of computer system 700. For example, data associated with programs that are executed or files accessed by cores 714 may be stored in system memory 707. Thus, a system memory 707 may include a system memory that stores data and/or sequences of instructions that are executed or otherwise used by the cores 714. In various embodiments, a system memory 707 may store persistent data (e.g., a user's files or instruction sequences) that remains stored even after power to the system memory 707 is removed. A system memory 707 may be dedicated to a particular CPU 702 or shared with other devices (e.g., one or more other processors or other devices) of computer system 700.

In various embodiments, a system memory 707 may include a memory comprising any number of memory arrays, a memory device controller, and other supporting logic (not shown). A memory array (or other memory described herein, such as memory used to store the signature and/or event counter values) may include non-volatile memory and/or volatile memory. Non-volatile memory is a storage medium that does not require power to maintain the state of data stored by the medium. Nonlimiting examples of nonvolatile memory may include any or a combination of: solid state memory (such as planar or 3D NAND flash memory or NOR flash memory), 3D crosspoint memory, memory devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D crosspoint memory may comprise a transistor-less stackable cross point architecture in which memory cells sit at the intersection of words lines and bit lines and are individually addressable and in which bit storage is based on a change in bulk resistance. Volatile memory is a storage medium that requires power to maintain the state of data stored by the medium. Examples of volatile memory may include various types of random access memory (RAM), such as dynamic random-access memory (DRAM) or static random-access memory (SRAM). One particular type of DRAM that may be used in a memory array is synchronous dynamic random-access memory (SDRAM). In some embodiments, any portion of memory 707 that is volatile memory can comply with JEDEC standards including but not limited to Double Data Rate (DDR) standards, e.g., DDR3, 4, and 5, or Low Power DDR4 (LPDDR4) as well as emerging standards.

A storage device 706 may store any suitable data, such as data used by processor 708 to provide functionality of computer system 700. For example, data associated with programs that are executed or files accessed by cores 714A and 714B may be stored in storage device 706. Thus, in some embodiments, a storage device 706 may store data and/or sequences of instructions that are executed or otherwise used by the cores 714A and 714B. In various embodiments, a storage device 706 may store persistent data (e.g., a user's files or software application code) that remains stored even after power to the storage device 706 is removed. A storage device 706 may be dedicated to CPU 702 or shared with other devices (e.g., another CPU or other device) of computer system 700.

In various embodiments, storage device 706 includes a storage device controller and one or more memory modules. In various embodiments, a memory module of storage device 706 comprises one or more NAND flash memory arrays, one or more hard disk drives, or other suitable memory storage devices. Storage device 706 may comprise any suitable type of memory and is not limited to a particular speed, technology, or form factor of memory in various embodiments. For example, a storage device 706 may be a disk drive (such as a solid-state drive), a flash drive, memory integrated with a computing device (e.g., memory integrated on a circuit board of the computing device), a memory module (e.g., a dual in-line memory module) that may be inserted in a memory socket, or other type of storage device. Moreover, computer system 700 may include multiple different types of storage devices. Storage device 706 may include any suitable interface to communicate with CPU memory controller 712 or I/O controller 710 using any suitable communication protocol such as a DDR-based protocol, PCI, PCIe, USB, SAS, SATA, FC, System Management Bus (SMBus), or other suitable protocol. A storage device 706 may also include a communication interface to communicate with CPU memory controller 712 or I/O controller 710 in accordance with any suitable logical device interface specification such as NVMe, AHCI, or other suitable specification. In particular embodiments, storage device 706 may comprise multiple communication interfaces that each communicate using a separate protocol with CPU memory controller 712 and/or I/O controller 710.

In some embodiments, all, or some of the elements of system 700 are resident on (or coupled to) the same circuit board (e.g., a motherboard). In various embodiments, any suitable partitioning between the elements may exist. For example, the elements depicted in CPU 702 may be located on a single die (i.e., on-chip) or package or any of the elements of CPU 702 may be located off-chip or off-package. Similarly, the elements depicted in storage device 706 may be located on a single chip or on multiple chips. In various embodiments, a storage device 706 and a computing device (e.g., CPU 702) may be located on the same circuit board or on the same device and in other embodiments the storage device 706 and the computing device may be located on different circuit boards or devices.

The components of system 700 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, and a Gunning transceiver logic (GTL) bus. In various embodiments, an integrated I/O subsystem includes point-to-point multiplexing logic between various components of system 700, such as cores 714, one or more CPU memory controllers 712, I/O controller 710, integrated I/O devices, direct memory access (DMA) logic (not shown), etc. In various embodiments, components of computer system 700 may be coupled together through one or more networks comprising any number of intervening network nodes, such as routers, switches, or other computing devices. For example, a computing device (e.g., CPU 702) and the storage device 706 may be communicably coupled through a network.

Although not depicted, system 700 may use a battery and/or power supply outlet connector and associated system to receive power, a display to output data provided by CPU 702, or a network interface allowing the CPU 702 to communicate over a network. In various embodiments, the battery, power supply outlet connector, display, and/or network interface may be communicatively coupled to CPU 702. Other sources of power can be used such as renewable energy (e.g., solar power or motion based power).

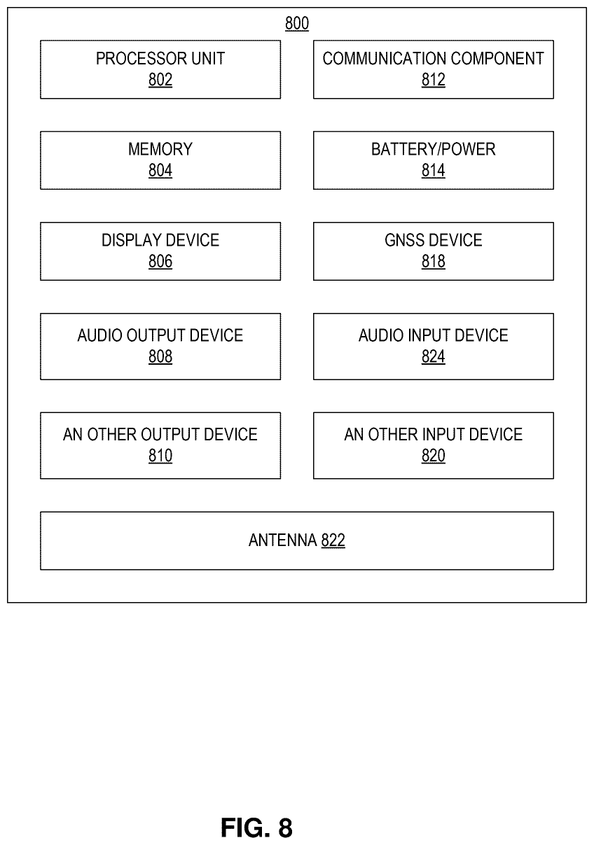

FIG. 8 is a block diagram of an example electronic device 800 according to certain embodiments of the present disclosure. Any suitable components of device 800 may be used to perform any of the functions described above. For example, any number of data corruption detectors may be included within device 800 or a component thereof.

A number of components are illustrated in FIG. 8 as included in the electronic device 800, but any one or more of these components may be omitted or duplicated, as suitable for the application. In some embodiments, some or all of the components included in the electronic device 800 may be attached to one or more motherboards mainboards, or system boards. In some embodiments, one or more of these components are fabricated onto a single system-on-a-chip (SoC) die.

Additionally, in various embodiments, the electronic device 800 may not include one or more of the components illustrated in FIG. 8, but the electronic device 800 may include interface circuitry for coupling to the one or more components. For example, the electronic device 800 may not include a display device 806, but may include display device interface circuitry (e.g., a connector and driver circuitry) to which a display device 806 may be coupled. In another set of examples, the electronic device 800 may not include an audio input device 824 or an audio output device 808, but may include audio input or output device interface circuitry (e.g., connectors and supporting circuitry) to which an audio input device 824 or audio output device 808 may be coupled.

The electronic device 800 may include one or more processor units 802 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 802 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electronic device 800 may include a memory 804, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 804 may include memory that is located on the same integrated circuit die as the processor unit 802. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electronic device 800 can comprise one or more processor units 802 that are heterogeneous or asymmetric to another processor unit 802 in the electronic device 800. There can be a variety of differences between the processing units 802 in a system in terms of a spectrum of metrics of merit including architectural, microarchitectural, thermal, power consumption characteristics, and the like. These differences can effectively manifest themselves as asymmetry and heterogeneity among the processor units 802 in the electronic device 800.

In some embodiments, the electronic device 800 may include a communication component 812 (e.g., one or more communication components). For example, the communication component 812 can manage wireless communications for the transfer of data to and from the electronic device 800. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 812 may operate in accordance with other wireless protocols in other embodiments. The electronic device 800 may include an antenna 822 to facilitate wireless communications and/or to receive other wireless communications (such as amplitude modulation (AM) or frequency modulation (FM) radio transmissions).

In some embodiments, the communication component 812 may manage wired communications, such as electrical, optical, or any other suitable communication protocols (e.g., IEEE 802.3 Ethernet standards). As noted above, the communication component 812 may include multiple communication components. For instance, a first communication component 812 may be dedicated to shorter-range wireless communications such as Wi-Fi or Bluetooth, and a second communication component 812 may be dedicated to longer-range wireless communications such as global positioning system (GPS), EDGE, GPRS, CDMA, WiMAX, LTE, EV-DO, or others. In some embodiments, a first communication component 812 may be dedicated to wireless communications, and a second communication component 812 may be dedicated to wired communications.

The electronic device 800 may include battery/power circuitry 814. The battery/power circuitry 814 may include one or more energy storage devices (e.g., batteries or capacitors) and/or circuitry for coupling components of the electronic device 800 to an energy source separate from the electronic device 800 (e.g., AC line power).

The electronic device 800 may include a display device 806 (or corresponding interface circuitry, as discussed above). The display device 806 may include one or more embedded or wired or wirelessly connected external visual indicators, such as a heads-up display, a computer monitor, a projector, a touchscreen display, a liquid crystal display (LCD), a light-emitting diode display, or a flat panel display.

The electronic device 800 may include an audio output device 808 (or corresponding interface circuitry, as discussed above). The audio output device 808 may include any embedded or wired or wirelessly connected external device that generates an audible indicator, such speakers, headsets, or earbuds.

The electronic device 800 may include an audio input device 824 (or corresponding interface circuitry, as discussed above). The audio input device 824 may include any embedded or wired or wirelessly connected device that generates a signal representative of a sound, such as microphones, microphone arrays, or digital instruments (e.g., instruments having a musical instrument digital interface (MIDI) output). The electronic device 800 may include a Global Navigation Satellite System (GNSS) device 818 (or corresponding interface circuitry, as discussed above), such as a Global Positioning System (GPS) device. The GNSS device 818 may be in communication with a satellite-based system and may determine a geolocation of the electronic device 800 based on information received from one or more GNSS satellites, as known in the art.

The electronic device 800 may include an other output device 810 (or corresponding interface circuitry, as discussed above). Examples of the other output device 810 may include an audio codec, a video codec, a printer, a wired or wireless transmitter for providing information to other devices, or an additional storage device.

The electronic device 800 may include an other input device 820 (or corresponding interface circuitry, as discussed above). Examples of the other input device 820 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electronic device 800 may have any desired form factor, such as a hand-held or mobile electronic device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electronic device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electronic device or an embedded computing system (e.g., computing systems that are part of a vehicle, smart home appliance, consumer electronics product or equipment, manufacturing equipment). In some embodiments, the electronic device 800 may be any other electronic device that processes data. In some embodiments, the electronic device 800 may comprise multiple discrete physical components. Given the range of devices that the electronic device 800 can be manifested as in various embodiments, in some embodiments, the electronic device 800 can be referred to as a computing device or a computing system.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein refers to circuitry and any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various components described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Example 1 includes an apparatus comprising a bus to communicate a plurality of signal sets in a plurality of transactions; first circuitry to generate a first signature based on the plurality of signal sets communicated by the bus, wherein the first circuitry is to update a signature based on a current value of the signature and a valid incoming signal set; and second circuitry to provide the first signature for comparison with a second signature.

Example 2 includes the subject matter of Example 1, and wherein the first signature is dependent on an order of the plurality of signal sets.

Example 3 includes the subject matter of any of Examples 1 and 2, and wherein the first signature is not dependent on an order of the plurality of signal sets.

Example 4 includes the subject matter of any of Examples 1-3, and further including third circuitry to generate a first counter value indicating a number of signal sets used to generate the first signature, and fourth circuitry to provide the first counter value or comparison with a second counter value indicating a number of signal sets used to generate a second signature.

Example 5 includes the subject matter of any of Examples 1-4, and wherein the first circuitry is further to generate a second signature based on a second plurality of signal sets communicated by the bus.

Example 6 includes the subject matter of any of Examples 1-5, and further including third circuitry to generate a second signature based on a second plurality of signal sets communicated by the bus.

Example 7 includes the subject matter of any of Examples 1-6, and wherein the plurality of signal sets comprise signals communicating one or more of at least one or more data bit, at least one address bit, or at least one control bit.

Example 8 includes the subject matter of any of Examples 1-7, and further including third circuitry to compress at least a portion of the signals of the plurality of signal sets to generate a plurality of compressed signal sets, and wherein the first signature is based on the plurality of compressed signal sets.

Example 9 includes the subject matter of any of Examples 1-8, and wherein the third circuitry comprises an XOR tree.

Example 10 includes the subject matter of any of Examples 1-9, and wherein the first circuitry comprises one or more of an accumulator, a multiple input shift register, or a linear feedback shift register to generate the first signature.

Example 11 includes the subject matter of any of Examples 1-10, and further including a processor comprising the bus.

Example 12 includes the subject matter of any of Examples 1-10, and further comprising one or more of a battery communicatively coupled to the processor, a display communicatively coupled to the processor, or a network interface communicatively coupled to the processor.

Example 13 includes a method comprising generating a first signature based on a first plurality of signal sets communicated by a bus in a first set of transactions; generating a second signature based on a second plurality of signal sets communicated by the bus in a second set of transactions; and comparing the first signature and the second signature to determine whether a data corruption error has occurred.

Example 14 includes the subject matter of Example 13, and further including incrementing an event counter associated with the first signature each time the first signature is updated based on a signal set.

Example 15 includes the subject matter of any of Examples 13 and 14, and further including reporting the data corruption error via an interface of a debugger.

Example 16 includes the subject matter of any of Examples 13-15, and further including compressing the first plurality of signal sets to generate a plurality of compressed signal sets and wherein the first signature is based on the plurality of compressed signal sets.

Example 17 includes the subject matter of any of Examples 13-16, and wherein the first signature is dependent on an order of the plurality of signal sets.

Example 18 includes the subject matter of any of Examples 13-17, and wherein the first signature is not dependent on an order of the plurality of signal sets.

Example 19 includes the subject matter of any of Examples 13-18, and further including generating a first counter value indicating a number of signal sets used to generate the first signature, and providing the first counter value for comparison with a second counter value indicating a number of signal sets used to generate the second signature.

Example 20 includes the subject matter of any of Examples 13-19, and wherein the first plurality of signal sets comprise signals communicating one or more of at least one or more data bit, at least one address bit, or at least one control bit.

Example 21 includes the subject matter of any of Examples 13-20, wherein the signature generation is performed by an accumulator, a multiple input shift register, or a linear feedback shift register.

Example 22 includes at least one machine readable storage medium having instructions stored thereon, the instructions when executed by a machine to cause the machine to generate a first signature based on a first plurality of signal sets communicated by a bus, wherein the first plurality of signal sets are communicated by the bus in different clock cycles; generate a second signature based on a second plurality of signal sets communicated by the bus, wherein the second plurality of signal sets are communicated by the bus in different clock cycles; and provide the first signature and the second signature for comparison to determine whether a data corruption error has occurred.

Example 23 includes the subject matter of Example 22, and wherein the instructions when executed are further to cause the machine to filter transactions on the bus that are to be used to generate the first signature.

Example 24 includes the subject matter of any of Examples 22-23, and wherein the instructions when executed are further to cause the machine to perform comparison of the first signature and the second signature.

Example 25 includes the subject matter of any of Examples 22-24, and wherein the instructions when executed are further to cause the machine to read the first signature and the second signature from at least one memory of the machine.

Example 26 includes the subject matter of any of Examples 22-25, and wherein the instructions when executed are further to cause the machine to increment an event counter associated with the first signature each time the first signature is updated based on a signal set.

Example 27 includes the subject matter of any of Examples 22-26, and wherein the instructions when executed are further to cause the machine to report the data corruption error via an interface of a debugger.

Example 28 includes the subject matter of any of Examples 22-27, and wherein the instructions when executed are further to cause the machine to compress the first plurality of signal sets to generate a plurality of compressed signal sets and wherein the first signature is based on the plurality of compressed signal sets.

Example 29 includes the subject matter of any of Examples 22-28, and wherein the first signature is dependent on an order of the first plurality of signal sets.

Example 30 includes the subject matter of any of Examples 22-29, and wherein the first signature is not dependent on an order of the first plurality of signal sets.

Example 31 includes the subject matter of any of Examples 22-30, and wherein the instructions when executed are further to cause the machine to generate a first counter value indicating a number of signal sets used to generate the first signature, and provide the first counter value for comparison with a second counter value indicating a number of signal sets used to generate the second signature.

Example 32 includes the subject matter of any of Examples 22-31, and wherein the first plurality of signal sets comprise signals communicating one or more of at least one or more data bit, at least one address bit, or at least one control bit.

Example 33 includes the subject matter of any of Examples 22-32, and wherein the signature generation is performed by an accumulator, a multiple input shift register, or a linear feedback shift register.

Example 34 includes a system comprising means for generating a first signature based on a first plurality of signal sets communicated by a bus in a first set of transactions; means for generating a second signature based on a second plurality of signal sets communicated by the bus in a second set of transactions; and means for comparing the first signature and the second signature to determine whether a data corruption error has occurred.

Example 35 includes the subject matter of Example 34, and further including means for incrementing an event counter associated with the first signature each time the first signature is updated based on a signal set.

Example 36 includes the subject matter of any of Examples 34 and 35, and further including means for reporting the data corruption error via an interface of a debugger.

Example 37 includes the subject matter of any of Examples 34-36, and further including means for compressing the first plurality of signal sets to generate a plurality of compressed signal sets and wherein the first signature is based on the plurality of compressed signal sets.

Example 38 includes the subject matter of any of Examples 34-37, and wherein the first signature is dependent on an order of the plurality of signal sets.

Example 39 includes the subject matter of any of Examples 34-38, and wherein the first signature is not dependent on an order of the plurality of signal sets.

Example 40 includes the subject matter of any of Examples 34-39, and further including means for generating a first counter value indicating a number of signal sets used to generate the first signature, and means for providing the first counter value for comparison with a second counter value indicating a number of signal sets used to generate the second signature.

Example 41 includes the subject matter of any of Examples 34-40, and wherein the first plurality of signal sets comprise signals communicating one or more of at least one or more data bit, at least one address bit, or at least one control bit.

Example 42 includes the subject matter of any of Examples 34-41, and wherein the signature generation is performed by an accumulator, a multiple input shift register, or a linear feedback shift register.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a bus to communicate a plurality of signal sets in a plurality of transactions;
first circuitry to generate a first signature based on the plurality of signal sets communicated by the bus, wherein the first circuitry is to update a signature based on a current value of the signature and a valid incoming signal set; and
second circuitry to provide the first signature for comparison with a second signature.

2. The apparatus of claim 1, wherein the first signature is dependent on an order of the plurality of signal sets.

3. The apparatus of claim 1, wherein the first signature is not dependent on an order of the plurality of signal sets.

4. The apparatus of claim 1, further comprising third circuitry to generate a first counter value indicating a number of signal sets used to generate the first signature, and fourth circuitry to provide the first counter value for comparison with a second counter value indicating a number of signal sets used to generate a second signature.

5. The apparatus of claim 1, wherein the first circuitry is further to generate a second signature based on a second plurality of signal sets communicated by the bus.

6. The apparatus of claim 1, further comprising third circuitry to generate a second signature based on a second plurality of signal sets communicated by the bus.

7. The apparatus of claim 1, wherein the plurality of signal sets comprise signals communicating one or more of: at least one or more data bit, at least one address bit, or at least one control bit.

8. The apparatus of claim 1, further comprising third circuitry to compress at least a portion of the signals of the plurality of signal sets to generate a plurality of compressed signal sets, and wherein the first signature is based on the plurality of compressed signal sets.

9. The apparatus of claim 8, wherein the third circuitry comprises an XOR tree.

10. The apparatus of claim 1, wherein the first circuitry comprises one or more of an accumulator, a multiple input shift register, or a linear feedback shift register to generate the first signature.

11. The apparatus of claim 1, further comprising a processor comprising the bus.

12. The apparatus of claim 11, further comprising one or more of a battery communicatively coupled to the processor, a display communicatively coupled to the processor, or a network interface communicatively coupled to the processor.

13. A method comprising:
generating a first signature based on a first plurality of signal sets communicated by a bus in a first set of transactions;
generating a second signature based on a second plurality of signal sets communicated by the bus in a second set of transactions; and
comparing the first signature and the second signature to determine whether a data corruption error has occurred.

14. The method of claim 13, further comprising incrementing an event counter associated with the first signature each time the first signature is updated based on a signal set.

15. The method of claim 13, further comprising reporting the data corruption error via an interface of a debugger.

16. The method of claim 13, further comprising compressing the first plurality of signal sets to generate a plurality of compressed signal sets and wherein the first signature is based on the plurality of compressed signal sets.

17. At least one machine readable storage medium having instructions stored thereon, the instructions when executed by a machine to cause the machine to:
generate a first signature based on a first plurality of signal sets communicated by a bus, wherein the first plurality of signal sets are communicated by the bus in different clock cycles;
generate a second signature based on a second plurality of signal sets communicated by the bus, wherein the second plurality of signal sets are communicated by the bus in different clock cycles; and
provide the first signature and the second signature for comparison to determine whether a data corruption error has occurred.

18. The at least one machine readable storage medium of claim 17, wherein the instructions when executed are further to cause the machine to filter transactions on the bus that are to be used to generate the first signature.

19. The at least one machine readable storage medium of claim 17, wherein the instructions when executed are further to cause the machine to perform comparison of the first signature and the second signature.

20. The at least one machine readable storage medium of claim 17, wherein the instructions when executed are further to cause the machine to read the first signature and the second signature from at least one memory of the machine.
